(19) United States
(12) Patent Application Publication
(10) Pub. No.: US 2025/0176578 A1
(43) Pub. Date: Jun. 5, 2025

(54) PROCESS FOR PREPARING FERMENTED DAIRY PRODUCT ANALOGUE WITH NON-DAIRY INGREDIENTS COMPRISING BETA-GLUCANS

(71) Applicant: SOCIETE DES PRODUITS NESTLE S.A., Vevey (CH)

(72) Inventors: IRMA LIDIA HERNANDEZ GARCIA, Beuvillers (FR); SELENE YADIRA GONZALEZ TOLEDO, Lisieux (FR); GIULIA MARCHESINI, Maracon (CH); LORETO ALONSO, Bern (CH)

(21) Appl. No.: 18/844,506

(22) PCT Filed: Mar. 10, 2023
(86) PCT No.: PCT/EP2023/056110

§ 371 Date: Sep. 6, 2024

(30) Foreign Application Priority Data
Mar. 11, 2022 (EP) 22161521.4

(51) Int. Cl. A23C 11/10

(52) U.S. Cl. CPC A23C 11/106; A23C 11/10

(57) ABSTRACT

The invention relates to a process for preparing a fermented dairy product analogue having reduced sliminess and/or stickiness while using non-dairy ingredients comprising beta-glucans. The process comprises the following steps. An edible suspension comprising hydrophilic liquid and at least one non-dairy ingredient is provided. The non-dairy ingredient comprises beta-glucans and is selected from the group consisting of plant ingredient, fungal ingredient, or a combination thereof. After providing the edible suspension, ascorbic acid is added into said edible suspension. The resulting edible suspension comprising ascorbic acid is then homogenized, heat-treated, inoculated with a starter culture, and fermented to obtain a fermented dairy product analogue. The invention also relates to a fermented dairy product analogue obtainable by such a process, to a method for reducing the adhesiveness of a fermented dairy product analogue and to the use of ascorbic acid for reducing adhesiveness of a fermented dairy product analogue.

### TECHNICAL FIELD

The present invention relates generally to the field of fermented food products. In particular, the present invention relates to a process for preparing a fermented dairy product analogue with non-dairy ingredients comprising beta-glucans, in particular fungal ingredient(s) and/or plant ingredient(s), preferably cereal ingredient(s). It also relates to a fermented dairy product analogue obtained with the process. It further relates to a method and use for reducing the sliminess and/or the stickiness in fermented dairy product analogues prepared with non-dairy ingredient(s) comprising beta-glucans, in particular fungal ingredient(s) and/or plant ingredient(s), preferably cereal ingredient(s).

### BACKGROUND OF THE INVENTION

Some consumers wish to reduce or even stop their consumption of milk and dairy products derived from milk. For example, this can be for reasons of lactose intolerance, dairy allergies, or environmental sustainability.

To meet this growing consumers' demand, food companies propose dairy products analogues, including fermented ones, on the market worldwide. These dairy products analogues are free from dairy ingredients and are prepared with alternative ingredients such as plant ingredients and/or fungal ingredients.

Among plant ingredient options, cereals are a substantial source of micro and macronutrients. Their consumption brings several nutritional and health benefits. Hence, food companies show great interest in using cereals as main ingredients for the preparation of dairy products analogues, including fermented ones.

For example, food companies commercialize plant-based drinking yogurts made from fermented oat and flavoured with fruit puree, such as mango or blackcurrant.

Such drinking yogurts usually contain low amount of ascorbic acid also known as Vitamin C, usually contain less than 0.03 wt % of ascorbic acid. Ascorbic acid in such low amount plays the role of antioxidant.

Cereals contain high concentrations of polysaccharides, including fibers. In particular, some cereals such as oat or barley comprise specific soluble fibers, called beta-glucans, in a substantial quantity. Beta-glucans are key macronutrients associated not only with health/nutritional benefits, but also functional properties. These high concentrations of beta-glucans may also be found in ingredients derived from such cereals. For example, this is the case for least refined cereal ingredients such as non-hydrolysed flours. However, the high concentrations of beta-glucans in these cereals and ingredients derived thereof, imply some challenges for the preparation of fermented dairy product analogue. Indeed, they alter textural properties of fermented dairy product analogues. They may provide unpleasant slimy and/or sticky textures which negatively impact the sensory experience.

WO2021/141659 describes a nutrient dense non-dairy food product comprising whole grain ingredient such as oat, protein mono- or disaccharide, fiber such as enzymatically treated pomace, fat and water. Enzymatically treated pomace contains around 3 wt % of dietary fibers, around 0.1 wt % of fat, around 1.3 wt % of protein, around 8.9 wt % of sugars and around 0.023 wt % of acid ascorbic. The use of enzymatically treated pomace allows to have a plant-based non-dairy food product high in fiber, with a reduced viscosity and therefore a reduced sliminess.

Cuina Wang et al. (Food Sci. Biotechnol 2018, 27 (3): 735-743) also describes fermented oat-based beverage in which ascorbic acid is added to improve the population of probiotic in the final product. However, the addition of ascorbic acid in the process for producing such oat-based beverage is done after the sterilization of the oat-based preparation leading a possible development of unwanted micro-organisms such as bacteria or mold in the fermented dairy product analogue.

To overcome the abovementioned challenges, highly refined cereal ingredients with no or minor concentrations of beta-glucans are used to prepare fermented dairy products analogues. In particular, these refined cereal ingredients are generally prepared by hydrolysing the beta-glucans in cereals and ingredients derived thereof by enzymatic reaction (e.g. with beta-glucanase).

However, highly refined ingredients may be characterized by lower nutritional properties. In addition, enzymatic hydrolysis may be intricate to implement industrially, and the use of enzymes in food products may be perceived as non-natural.

In addition, there is a growing interest for fungal ingredients and their use in dairy product analogues is explored by food companies. These fungal ingredients are derived from unicellular or pluricellular fungi. Like cereals, they may also comprise a substantial content of beta-glucans. Due to their beta-glucans content, the use of fungal ingredients may potentially also raise one or more of the abovementioned challenges when preparing fermented dairy products analogues.

Hence, there remains the need to provide a non-enzymatic solution to prepare a fermented dairy product analogue having a satisfactory texture, i.e., having reduced sliminess and/or reduced stickiness while using non-dairy ingredients comprising substantial quantity of beta-glucans, in particular fungal ingredient(s) and/or plant ingredient(s), preferably cereal ingredient(s).

It is desirable that this non-enzymatic solution is effective at providing the above-mentioned advantage even when the fermented dairy product analogue is prepared with least refined fungal ingredients and/or plant ingredients, preferably least refined cereal ingredients such as non-hydrolysed cereal flours.

It is also desirable that said non-enzymatic solution provide a fermented dairy products analogue with satisfactory texture as mentioned above even in presence of substantial amount of beta-glucans-containing fungal ingredients and/or plant ingredients, preferably cereal ingredients, and so of beta-glucans.

### SUMMARY OF THE INVENTION

The object of the present invention is to improve the state of the art, and in particular to provide a process, a fermented dairy product analogue, a method and a use that overcome the problems of the prior art and addresses the needs described above, or at least to provide a useful alternative.

The inventors were surprised to see that the object of the present invention could be achieved by the subject matter of the independent claims. The dependent claims further develop the idea of the present invention.

Accordingly, a first aspect of the invention proposes a process for preparing a fermented dairy product analogue comprising the steps of:
a) providing an edible suspension comprising hydrophilic liquid and at least one non-dairy ingredient, wherein the non-dairy ingredient comprises beta-glucans and wherein the non-dairy ingredient is selected from the group consisting of plant ingredient, fungal ingredient or a combination thereof,
b) adding ascorbic acid into the edible suspension to obtain an edible suspension comprising ascorbic acid,
c) homogenizing the edible suspension comprising ascorbic acid,
d) heat-treating the edible suspension comprising ascorbic acid,
e) inoculating the homogenised and heat-treated edible suspension comprising ascorbic acid with a starter culture to obtain an inoculated edible suspension comprising ascorbic acid,
f) fermenting the inoculated edible suspension comprising ascorbic acid until reaching a pH of less than 5.0 to obtain a fermented dairy product analogue.

A second aspect of the invention proposes a fermented dairy product analogue which comprises:
hydrophilic liquid,
at least one non-dairy ingredient, wherein the non-dairy ingredient comprises beta-glucans and wherein the non-dairy ingredient is selected from the group consisting of plant ingredient, fungal ingredient or a combination thereof,
ascorbic acid.

A third aspect of the invention proposes a method for reducing the adhesiveness of a fermented dairy product analogue which comprises the step of adding ascorbic acid to an edible suspension before fermentation of said edible suspension with a starter culture, wherein said edible suspension comprises hydrophilic liquid and at least one non-dairy ingredient, wherein the non-dairy ingredient comprises beta-glucans and wherein the non-dairy ingredient is selected from the group consisting of plant ingredient, fungal ingredient or a combination thereof.

A fourth aspect of the invention proposes the use of ascorbic acid for reducing adhesiveness of a fermented dairy product analogue, wherein the fermented dairy product analogue comprises at least one non-dairy ingredient, wherein the non-dairy ingredient comprises beta-glucans and wherein the non-dairy ingredient is selected from the group consisting of plant ingredient, fungal ingredient or a combination thereof.

It has been discovered that the use of ascorbic acid in the preparation of fermented dairy product analogues enables to achieve a good texture despite the presence of fungal ingredients and/or plant ingredient, in particular cereal ingredients, comprising a substantial content of beta-glucans. More particularly, the use of ascorbic acid enables to significantly reduce the slimy texture and/or the sticky texture of such fermented dairy product analogues prepared with fungal ingredients and/or plant ingredient, in particular cereal ingredients, comprising a substantial content of beta-glucans.

These and other aspects, features and advantages of the invention will become more apparent to those skilled in the art from the detailed description of embodiments of the invention, in connection with the attached drawings.

### BRIEF DESCRIPTION OF THE DRAWINGS

FIG. 1 shows the adhesiveness of fermented plant-based yogurt analogues at 8° C., formed through fermentation with starter culture A or starter culture A+Lj1 at 37° C., and in presence (0.05 wt %) or absence (0.00%) of ascorbic acid. The yogurt analogues contain non-hydrolysed oat flour and either faba or pea protein isolates. Significant differences between yogurt analogues with 0.05 wt % ascorbic acid (mesh bars) and their control, i.e. without ascorbic acid (white bars) were determined at an α=0.05. * means p≤0.05; ** means p≤0.01, and *** means p≤0.001.

FIG. 2 shows the adhesiveness of fermented plant-based yogurt analogues comprising hydrolysed oat flour (without the addition of pulse proteins) at 8° C. The initial cereal suspension was added with different concentrations of ascorbic acid (0, 0.05 wt %, 0.10 wt %, 0.25 wt % and 0.50 wt %) then fermented with starter culture A at 37° C. for 4.5 hours. The adhesiveness of each yogurt analogues containing ascorbic acid was compared to that of the control, i.e. without ascorbic acid, and among treatments with different concentration of ascorbic acid. Significant differences were determined at an α=0.05. * means p≤0.05; ** means p≤0.01, * means p≤0.001, and ns means not significant.

FIG. 3 shows the adhesiveness of fermented plant-based yogurt analogues not according to the invention containing corn starch or rice flour (without the addition of pulse proteins) at 8° C. in presence (0.05 wt %) or absence (0.00%) of ascorbic acid. Each sample was fermented with starter culture A at 37° C. for 4.5 hours. The adhesiveness of yogurt analogues containing ascorbic acid was compared to that of the control, i.e. yogurt analogues without ascorbic acid. No significant differences were found between the yogurt analogues containing 0.05% ascorbic acid and that of their respective control.

FIG. 4 shows the adhesiveness of “chilled” (i.e. no second heat-treatment) fermented plant-based yogurt analogues at 8° C. prepared in presence of ascorbic acid (0.05%), sodium ascorbate (0.05 wt %) or in absence of both ascorbic acid and sodium ascorbate (=control). Each sample was fermented with starter culture A at 43° C. The yogurt analogues contain oat flour and faba protein isolates. Significant differences between yogurt analogues with 0.05 wt % ascorbic acid or sodium ascorbate and their control (dotted bar) were determined at an α=0.05. * means p≤0.05; ** means p≤0.01, and *** means p≤0.001.

FIG. 5 shows the adhesiveness of fermented plant-based yogurt analogues containing hydrolysed oat flour prepared at 8° C. in presence of ascorbic acid (0.05 wt %), the oat and ascorbic acid were left reacted respectively for 2 minutes and for 20 minutes before adjusting the pH and before adding the other ingredients. Each sample was fermented with starter culture A at 37° C. for 4.5 hours.

FIG. 5 also shows the adhesiveness of fermented plant-based yogurt analogue named BF containing hydrolysed oat flour and pea protein isolates prepared at 8° C. and pasteurized. Ascorbic acid (0.05%) was added to this pasteurized plant-based yogurt and fermented with starter culture A at 37° C. for 4.5 hours.

### DETAILED DESCRIPTION OF THE INVENTION

As used in the specification, the words “comprise”, “comprising” and the like are to be construed in an inclusive sense, that is to say, in the sense of “including, but not limited to”, as opposed to an exclusive or exhaustive sense.

As used in the specification, the singular forms “a”, “an”, and “the” include plural referents unless the context clearly dictates otherwise.

Unless noted otherwise, all percentages in the specification refer to weight percent, where applicable.

Unless defined otherwise, all technical and scientific terms have and should be given the same meaning as commonly understood by one of ordinary skill in the art to which this invention belongs.

As used in the present invention, the term “native beta-glucans” refers to beta-glucans which are not hydrolysed.

In the present context, the term “initial total beta-glucans” refers to all beta-glucans within a food ingredient, e.g. cereal flour, before enzymatic hydrolysis, for example with a beta-glucan-degrading enzyme, in particular with an enzyme comprising beta-glucanase activity or side activity.

In the present context, the term “fermentable sugars” refers to sugars which can be converted enzymatically into organic acids, such as lactic acid, acetic acid and the like, by starter cultures upon fermentation. The fermentable sugar is not of dairy origin and sugars derived from milk such as lactose are excluded from this definition.

In the present context, the term “fermented dairy product analogue” refers to a fermented edible food product comprising one or more ingredients derived from plant materials and/or fungal materials, which is free from dairy ingredients, and which mimics the texture, and also preferably the visual aspect, of fermented dairy products. Examples of fermented dairy products include fermented milk, yogurts, kefir or a combination thereof.

In the present context, the term “drinkable fermented dairy product analogue” relates to a fermented dairy product analogue having a flowing consistency such that it can be consumed by drinking.

In the present context, the term “spoonable fermented dairy product analogue” relates to a fermented dairy product analogue having a consistency (i.e., not too liquid) such that it can be consumed with a spoon.

As used in the present invention, the term “sliminess” refers to the extent to which a liquid or semi-liquid food product falls as a continuous thread when a back of a spoon is contacted with the surface of the food product and is then removed from said surface. The spoon has to be coated with the food product before contacting its back with the surface of the food. The coating of the spoon with the food product may be performed by immersing the spoon in said food product. The slimier the product is, the longer the continuous thread takes to break.

As used in the present invention, the term “stickiness” refers to the extent to which a food product sticks to the teeth and/or palate during biting, chewing and/or during movement in the mouth. The stickier the product is, the more it sticks to the teeth and/or palate during biting, chewing and/or during movement in the mouth.

In a first aspect, the invention relates to a process for preparing a fermented dairy product analogue.

The fermented dairy product analogue may be drinkable or spoonable fermented dairy product analogue. For example, the fermented dairy product analogue may be selected from the group consisting of fermented milk analogue, yogurt analogue, kefir analogue, skyr analogue, cottage cheese analogue, fresh cheese analogues or a combination thereof.

Preferably, the fermented dairy product analogue is spoonable, more preferably spoonable yogurt analogue. For example, the spoonable yogurt analogue may be Greek yogurt analogue.

In an embodiment, the fermented dairy product analogue may be a chilled fermented dairy product analogue. By “chilled”, it is understood a fermented dairy product analogue which has a shelf-life of several days when stored under chilled conditions. The term “chilled conditions” refers to temperatures ranging from 2° C. to 14° C., preferably from 2° C. to 10° C., more preferably from 4° C. to 8° C. Especially, a chilled fermented dairy product analogue has a shelf-life of at least 25 days, preferably of at least 30 days when stored under chilled conditions. These storage temperatures relate to the storage of the product before being commercially obtained by an end consumer. Generally, the end consumer is advised to store the product under the same chilled conditions until consumption, for example in a refrigerator.

In another embodiment, the fermented dairy product analogue may be a shelf-stable fermented dairy product analogue. By “shelf-stable”, it is understood a fermented dairy product analogue which has a shelf-life of several months when stored under ambient conditions. This also generally applies when it is stored under chilled conditions. The term “ambient conditions” refers to temperatures ranging from 15° C. to 25° C., preferably from 20° C. to 22° C. Especially, a shelf-stable fermented dairy product analogue has a shelf-life of at least 3 months, preferably of at least 6 months when stored under ambient conditions. These storage temperatures relate to the storage of the product before being commercially obtained by an end consumer. Generally, the end consumer is advised to store the product under the same ambient conditions until consumption, for example in a shelf at room temperature.

The process comprises a step a) of providing an edible suspension. The edible suspension comprises a hydrophilic liquid and at least one non-dairy ingredient.

The hydrophilic liquid forms the liquid matrix of the edible suspension. The hydrophilic liquid may also contribute to the taste, the texture and the nutritional properties of the fermented dairy product analogue. By “hydrophilic liquid”, it is understood a liquid or semi-liquid composition which comprises at least 60% water, more preferably at least 70% water. In particular, the hydrophilic liquid is not derived from milk. For example, milk, dairy creams, are excluded from this definition. In a preferred embodiment, the hydrophilic liquid may be selected from the group consisting of water, plant-based milk alternative, plant-based cream alternative or a mixture thereof. Examples of plant-based milk alternative include almond milk, cashew milk, coconut milk, hazelnut milk, flaxseed milk, lupine milk, oat milk, pea milk, peanut milk, pine nut milk, rice milk, sesame seed milk, soybean milk, sunflower seed milk, walnut milk or a mixture thereof. Examples of plant-based cream alternative include almond cream, cashew cream, coconut cream, hazelnut cream, oat cream, peanut cream or a mixture thereof. The edible suspension may comprise from 60 wt. % to 97 wt. %, preferably from 70 wt. % to 95 wt. %, more preferably from 80 wt. % to 95 wt. % of hydrophilic liquid with respect to the total weight of the edible suspension.

The non-dairy ingredient of the edible suspension comprises beta-glucans, in particular native beta-glucans. The non-dairy ingredient is selected from the group consisting of plant ingredient, fungal ingredient, or a combination thereof. In the context of the invention, fungal ingredients refer to ingredients which are derived from unicellular fungi or pluricellular fungi (e.g. mushrooms) and which comprise beta-glucans. Examples of fungal ingredients comprising beta-glucans include beta-glucans-containing ingredients which are derived from the group consisting of Saccharomyces cerevisae, Agaricus bisporus, Trametes versicolor, Pleurotus ostreatus, Lentinula edodes, Grifola frondose or a mixture thereof. In the context of the invention, plant ingredients which comprise beta-glucans refers to ingredients which are derived from plants, and which comprise beta-glucans. Examples of plant ingredients comprising beta-glucans include beta-glucans-containing ingredients which are derived from cereals. The non-dairy ingredient may comprise a substantial content of beta-glucans, in particular native beta-glucans. In other words, the non-dairy ingredient may comprise at least 0.5 wt. %, preferably from 0.5 to 35.0 wt. %, more preferably from 1.0 to 10.0 wt. %, even more preferably from 1.5 to 5.0 wt. % of beta-glucans, in particular native beta-glucans, with respect to the total weight of the non-dairy ingredient.

In a preferred embodiment, the non-dairy ingredient may be a cereal ingredient, in particular a cereal ingredient which comprises beta-glucans. In particular, the cereal ingredient may be originated from a cereal which inherently comprises substantial content of beta-glucans, in particular native beta-glucans. In particular, the cereal ingredient may be originated from the group consisting of oat, barley, rye, wheat or a combination thereof. Preferably, the cereal ingredient may be originated from oat and/or barley. Oat and barley are cereals with the highest content of beta-glucans, in particular native beta-glucans. More preferably, the cereal ingredient may be only originated from oat. Examples of cereal ingredient include cereal flour, cereal protein concentrate, cereal bran powder, liquid cereal bran, cereal beta-glucans concentrate or a combination thereof.

In a further preferred embodiment, the cereal ingredient is a cereal flour. In particular, the cereal ingredient is a cereal flour originated from one or more of the cereals mentioned above. Cereal flour is a powder ingredient which is obtained by physical treatment, in particular grinding, of cereals. Cereal flours are known by the one skilled in the art and are commercially available. Due to its process, cereal flours are generally rich in beta-glucans. Preferably, the cereal flour is oat flour and/or barley flour. The cereal flour may be non-hydrolysed cereal flour, partially hydrolysed cereal flour or a combination thereof. A non-hydrolysed cereal flour is flour wherein no beta-glucans (from the initial total beta-glucans), have been hydrolysed by enzymatic treatment, for example with a beta-glucan-degrading enzyme such as enzyme comprising beta-glucanase activity or side activity. In contrast, a partially hydrolysed cereal flour is flour wherein part (i.e. not all) of beta-glucans, i.e. part of the initial total beta-glucans, have been hydrolysed by enzymatic treatment, for example with a beta-glucan-degrading enzyme such as enzyme comprising beta-glucanase activity or side activity. In a more preferred embodiment, the cereal flour is non-hydrolysed cereal flour. The non-hydrolysed cereal flour may be wholegrain cereal flour.

The process of the invention allows the preparation of a fermented dairy product analogue with good texture, in particular with reduced sliminess and/or stickiness, starting from non-dairy ingredients with substantial content of beta-glucans, in particular fungal ingredients and/or plant ingredients, preferably cereal ingredients. In particular, this may be achieved even when starting from cereal flours, in particular non-hydrolysed cereal flours, which are rich in beta-glucans. In addition, partially hydrolysed cereal flours still comprise beta-glucans. The process of the invention may allow to improve the texture, in particular to further decrease sliminess and/or stickiness, of fermented dairy products analogues prepared with partially hydrolysed cereal flours.

In an embodiment, the edible suspension comprises from 1.0 to 15 wt %, preferably from 2.0 to 10 wt %, more preferably from 3.5 to 9 wt. % of non-dairy ingredient with respect to the total weight of the edible suspension. Above this range, a dough is generally obtained instead of an edible suspension. Due to its solid consistency, such a dough is unsuitable for the preparation of fermented dairy product analogues. Below this range, the texture of fermented dairy product analogues may be too low and so unsatisfactory.

In an embodiment, the fermented dairy product analogue may further comprise at least one ingredient selected from the group consisting of a plant protein ingredient which is different from the non-dairy ingredient, a vegetable fat component, a fermentable sugar component or combination thereof.

In an additional embodiment, the edible suspension may further comprise at least one plant protein ingredient which is different from the non-dairy ingredient, and which is selected from the group consisting of plant protein concentrate, plant protein isolate, plant protein flour or a mixture thereof. In an embodiment, the edible suspension may comprise from 0.1 to 10 wt %, preferably from 0.5 to 5 wt %, more preferably from 1 to 5 wt. % of plant protein ingredient with respect to the total weight of the edible suspension.

The plant protein ingredient may contribute to the nutritional profile of the fermented dairy product analogue by providing proteins and by improving the PDCAAS. In addition, it may contribute to the texture. Indeed, the plant proteins of the plant protein ingredient may form a plant protein network upon acidification during fermentation. This plant protein network promotes the increase of texture via the formation of a gel. The plant protein ingredient may comprise plant proteins selected from the list consisting of pulse proteins, cereal proteins, nut proteins, oilseed proteins or a mixture thereof.

In a preferred embodiment, the plant protein ingredient may comprise pulse proteins. More preferably, the plant protein ingredient may consist only of pulse proteins. The pulse proteins may be selected from the group consisting of bean proteins, chickpea proteins, faba bean proteins, lentil proteins, lupine proteins, pea proteins or a mixture thereof.

Advantageously, the pulse proteins may be selected from the group consisting of pea proteins, faba bean proteins or a mixture thereof. Pulse proteins, in particular pea and faba bean proteins, have good gelling properties upon fermentation. They also allow to improve the PDCAAS of the final product, in particular when the final product is based on cereal ingredient(s).

In another embodiment, the edible suspension may further comprise a vegetable fat component. In an embodiment, the edible suspension may comprise from 0.5 to 10 wt %, preferably from 0.5 to 5 wt %, more preferably from 1.0 to 5 wt. % of vegetable fat with respect to the total weight of the edible suspension.

The vegetable fat component is provided through one or more ingredient(s) other than the non-dairy ingredient and/or the hydrophilic liquid. The vegetable fat component may contribute to the creaminess of the fermented dairy product analogue. More preferably, the vegetable fat component is vegetable oil. The vegetable oil is selected among the list consisting of almond oil, argan oil, avocado oil, canola oil, coconut oil, corn oil, cottonseed oil, grapeseed oil, hazelnut oil, hemp seed oil, macadamia nut oil, oat bran oil, olive oil, palm oil, peanut oil, pistachio oil, rapeseed oil, rice bran oil, soybean oil, sesame oil, sunflower seed oil, walnut oil or a mixture thereof.

In an additional embodiment, the edible suspension may further comprise a fermentable sugar component. In an embodiment, the edible suspension may comprise from 0.5 to 10 wt %, preferably from 0.5 to 5 wt %, more preferably from 1.0 to 5 wt. % of fermentable sugar component with respect to the total weight of the edible suspension.

The fermentable sugar component is provided through one or more ingredient(s) other than the non-dairy ingredient and/or the hydrophilic liquid. Preferably, the fermentable sugar component is selected from the group consisting of agave syrup, brown sugar, coconut sugar, corn syrup, dextrose, fructose, glucose, honey, invert sugar, maltose, molasse, sucrose, or a mixture thereof. More preferably, the fermentable sugar component is sucrose. The fermentable sugar component may be added to provide sweetness, texture and/or nutritional properties to the final fermented dairy product analogue. In addition, they may also be added to optimize the processing steps. For example, fermentable sugars may be added to ensure an efficient fermentation step.

In a particular embodiment, the ingredient selected from the group consisting of a plant protein ingredient which is different from the non-dairy ingredient, a vegetable fat component, a fermentable sugar component or combination thereof may be added before addition of ascorbic acid, i.e during the step a, or after addition of ascorbic acid, i.e. after step b) and before step c).

In a particular embodiment, the edible suspension may have a total protein content of at least 0.5 wt. %, preferably from 0.5 wt. % to 8 wt. %, more preferably from 1.5 wt. % to 6.0 wt. %, most preferably from 2.2 wt. % to 5.5 wt. % with respect to the total weight of the edible suspension. The edible suspension may have a total fat content of at least 0.1 wt. %, preferably from 0.1 wt. % to 10 wt. %, more preferably from 1 wt. % to 10 wt. %, most preferably from 1.5 wt. % to 8 wt. %. The edible suspension may have a total sugar content of at least 0.1 wt. %, preferably from 0.1 wt. % to 15 wt. %, more preferably from 1.0 wt. % to 12 wt. %, most preferably from 1.5 wt. % to 8 wt. % with respect to the total weight of the edible suspension.

Hence, the abovementioned details in relation with the total protein content, the total fat content and the total sugar content may also apply to the edible suspension comprising ascorbic acid.

The edible suspension may further comprise one or more additional ingredients such as buffering agent, flavours, fibers, colorants, prebiotics, yeast extract, texturizing agents, fruit preparation, vegetable preparation, solid inclusions or a combination thereof. The additional ingredient(s) may be added in the edible suspension obtained in step a) or in the edible suspension comprising ascorbic acid obtained in step b). They may also be added in the edible suspension comprising ascorbic acid obtained in step c).

The process further comprises a step b) of adding ascorbic acid into the edible suspension obtained in step a) to obtain an edible suspension comprising ascorbic acid. Preferably, ascorbic acid is L-ascorbic acid. Also preferably, the ascorbic acid is not under the form of a salt, in particular is not under the form of ascorbate salt.

It has been observed that the addition of ascorbic acid allows to improve the texture of fermented dairy product analogues prepared with non-dairy ingredients, in particular fungal ingredients and/or plant ingredients, which have a substantial content of beta-glucans. In particular, this is observed when the non-dairy ingredients are cereal ingredients, including cereal flours such as non-hydrolysed cereal flours. It has been observed that the use of ascorbic acid allows to significantly decrease the unpleasant sliminess and/or stickiness of such fermented dairy product analogues such that a satisfactory and pleasant texture is achieved.

Such a satisfactory texture may be achieved without using any beta-glucan-degrading enzymes, in particular enzymes comprising beta-glucanase activity or side activity. Hence, in an advantageous embodiment, the process does not comprise any step of addition of any beta-glucans-degrading enzymes, in particular any enzymes comprising beta-glucanase activity or side activity. More advantageously, the process does not comprise any step of addition of any carbohydrate-degrading enzymes. For example, the carbohydrate-degrading enzymes may be selected from the group consisting of enzymes comprising beta-glucanase activity or side-activity, enzymes comprising alpha-amylase activity or side activity, enzymes comprising beta-amylase activity or side activity, enzymes comprising amyloglucosidase activity or side activity, enzymes comprising pullulanase activity or side activity or a combination thereof. Even more advantageously, the process does not comprise any step of addition of any enzymes.

In an embodiment, the edible suspension may comprise from 0.05 wt. %, to 0.60 wt. %, preferably from 0.05 wt. % to 0.50 wt. %, of ascorbic acid with respect to the total weight of the edible suspension. At these concentrations, ascorbic acid effectively decreases the sliminess and/or stickiness of fermented dairy product analogues prepared with non-dairy ingredients which have a substantial content of beta-glucans, in particular fungal ingredients and/or plant ingredients, preferably cereal ingredients. Without wishing to be bound by theory, it is believed that outside this range the effectiveness of ascorbic acid on improving the texture by decreasing the sliminess and/or stickiness is significantly reduced.

In a preferred embodiment, the ascorbic acid is added at least 20 minutes, preferably from 20 minutes to 150 minutes, more preferably from 30 minutes to 130 minutes before the heat-treatment step (i.e. step d). Without wishing to be bound by theory, it is believed that the period of time between the addition of ascorbic acid to the edible suspension and the heat-treatment step, also called “reaction time”, allows to maximize the effect of the ascorbic acid on the texture, in particular sliminess and/or stickiness, of the fermented dairy product analogues. Outside this reaction time range, it is believed that the effectiveness of the ascorbic acid is reduced due to insufficient reaction time or due to potential undesirable side reactions.

In an embodiment, the ascorbic acid may be added at least 20 minutes, preferably 20 minutes to 150 minutes, more preferably 30 minutes to 130 minutes before addition of any ingredients.

In an embodiment, after addition of ascorbic acid, the pH of the edible suspension comprising ascorbic acid may be adjusted to a pH comprised between 6 and 7, preferably between 6.5 and 7. The pH adjustment may be performed by addition of a food grade alkalinizing agent, such as sodium hydroxide. For example, any ingredients may be added to the edible suspension comprising ascorbic acid after the pH adjustment step, if any. For example, the plant protein ingredient may be added to the edible suspension comprising ascorbic acid after the pH adjustment step, if any.

The process further comprises a step c) of homogenizing the edible suspension comprising ascorbic acid obtained in step b). The homogenization step is performed at a pressure of at least 50 bars. Preferably, the homogenization step is performed at a pressure of 50 bars to 700 bars, more preferably of 50 bars to 500 bars, even more preferably of 50 bars to 300 bars, most preferably of 100 bars to 300 bars. In one embodiment, the homogenization step is performed at a temperature ranging from 50° C. to 70° C., preferably from 55° C. to 65° C.

The process further comprises a step d) of heat treating the edible suspension comprising ascorbic acid. The heat-treatment step may be performed at a temperature ranging from 80° C. to 100° C. for 1 to 15 minutes, preferably for 1 to 8 minutes. In a preferred embodiment, the heat treatment is performed at a temperature ranging from 85° C. to 95° C. for 1 to 15 minutes, preferably for 1 to 8 minutes. This heat treatment prevents any development of unwanted micro-organisms in the fermented dairy product analogue, such as bacteria or moulds that may affect negatively the organoleptic properties of the fermented dairy product analogue, or that may be pathogenic.

The heat treatment step may be performed prior or after the homogenization step. In a preferred embodiment, the heat treatment is performed after the homogenization step. Indeed, for hygienic and manufacturing purposes, it is preferable that the heat treatment is performed after the homogenization step. Indeed, it ensures the elimination of any unwanted micro-organisms that could be brought during the homogenization step, especially if a non-aseptic homogenizing equipment is used. Moreover, when the homogenization step is performed with a non-aseptic homogenizing equipment and is performed after the heat treatment step, it would require performing an additional heat treatment after the homogenizing step. Such an additional heat treatment makes the process more complex to be implemented. Moreover, it is desired to minimize the number of heat treatments as heat treatments may negatively impact the nutritional composition and sensory profile of the final product.

After the homogenization step and the heat-treatment step, a homogenised and heat-treated edible suspension comprising ascorbic acid is obtained. The process further comprises a step e) of inoculating said homogenised and heat-treated edible suspension comprising ascorbic acid with a starter culture to obtain an inoculated edible suspension comprising ascorbic acid. By “starter culture”, it is understood one or more food-grade microorganism(s) which are suitable for fermenting a food substrate. They may also be used as probiotic, i.e. to impart health benefits in the consumers upon consumption, such as health benefits for the gut.

In an embodiment, the starter culture may comprise at least one lactic acid-producing bacteria. In particular, the lactic acid-producing bacteria is selected from the group consisting of Lactobacillus, Lacticaseibacillus, Lactiplantibacillus, Leuconostoc, Pediococcus, Lactococcus, Streptococcus, Bifidobacterium, Carnobacterium, Oenococcus, Sporolactobacillus, Tetragenococcus, Vagococcus, Weissella, or a combination thereof, preferably selected from the group consisting of Lactobacillus, Lacticaseibacillus, Lactiplantibacillus, Lactococcus, Streptococcus, Bifidobacterium or a combination thereof, further preferably selected from the group consisting of Lactobacillus, Lacticaseibacillus, Lactiplantibacillus, Streptococcus, Bifidobacterium or a combination thereof, most preferably selected from the group consisting of Streptococcus, Lactobacillus, or a combination thereof.

In an embodiment, the starter culture may further comprise, in addition to the lactic acid-producing bacteria, at least one yeast and/or at least one acetic acid-producing bacteria.

Preferably, the yeast may be selected from the group consisting of Zygosaccharomyces, Candida, Kloeckera/Hanseniaspora, Torulaspora, Pichia, Brettanomyces/Dekkera, Saccharomyces, Lachancea, Saccharomycoides, Schizosaccharomyces Kluyveromyces or a combination thereof. More preferably, the yeast may be selected from the list consisting of Saccharomyces, Kluyveromyces or a combination thereof. Preferably, the acetic acid-producing bacteria may be selected from the group consisting of Acetobacter and Gluconacetobacter. These strains, in addition to lactic acid-producing strain, are for example used to produce dairy kefirs. Hence, by using these strains, the fermented dairy product analogue of the invention may, for example, further mimic standard dairy kefirs.

In a preferred embodiment, the starter culture may consist only of one or more lactic acid-producing bacteria. Preferably, the at least one starter culture may consist of one or more thermophilic lactic acid-producing bacteria strains. The term “thermophilic lactic acid-producing bacteria strains” refers to lactic acid-producing bacteria strains having an optimal growth at a temperature between 35° C. and 45° C. More preferably, the starter culture may be selected among the list consisting of Lactobacillus delbrueckii subsp. bulgaricus, Lacticaseibacillus paracasei, Lactobacillus acidophilus, Streptococcus thermophilus, Lactobacillus johnsonii, Bifidobacterium species or a combination thereof. Most preferably, the starter may consist of a combination of Lactobacillus delbrueckii subsp. bulgaricus and Streptococcus thermophilus. Especially, Lactobacillus delbrueckii subsp. bulgaricus and Streptococcus thermophilus are the two staple strains that are used in standard dairy yogurts. By using these strains, the fermented dairy product analogues of the invention may further mimic standard dairy yogurts.

Advantageously, any of the above-mentioned starter culture may be non-dairy starter culture, i.e. may be free from dairy ingredients.

The process further comprises a step f) of fermenting the inoculated edible suspension comprising ascorbic acid until reaching a pH of less than 5.0, preferably less than 4.8, more preferably less than 4.8 to obtain a fermented dairy product analogue. In a preferred embodiment, the fermentation step may be performed until reaching a pH comprised between 3.0 and 5.0, preferably between 3.5 and 4.8, more preferably between 3.5 and 4.6. In an embodiment, the fermentation step may last for at least 4 hours, preferably from 4 to 16 hours, more preferably from 4 to 8 hours, most preferably from 5 to 6 hours.

In a further embodiment, the fermentation step is performed at the temperature of optimal growth of the starter culture. The temperature of optimal growth of the starter culture may be easily determined by the person skilled in the art. For example, the fermentation step is performed at temperature ranging from 25° C. to 45° C., preferably from 35° C. to 45° C., for example at 37° C.

The process may further comprise, after the fermentation step f), a step of heat treating the fermented dairy product analogue to obtain a shelf-stable fermented dairy product analogue. In particular, the heat-treatment is performed at a temperature ranging from 75° C. to 125° C. for 2 to 90 seconds. Preferably, the heat treatment is performed at a temperature ranging from 100° C. to 120° C. for 2 seconds to 90 seconds. More preferably, the heat treatment is performed at a temperature ranging from 100° C. to 120° C. for 2 seconds to 60 seconds, preferably for 2 seconds to 40 seconds.

This second heat treatment enables to considerably extend the shelf-life of the fermented dairy product analogue. In particular, this enables to provide a shelf-stable fermented dairy product analogue which product may be stored under ambient conditions for several months without involving sanitary risks.

The process may comprise a step of smoothing the fermented dairy product analogue after the fermentation step. This smoothing step may occur before the heat-treatment after the fermentation step, if any.

The smoothing step may be performed with a rotor stator smoothing device as described in EP1986501 A1. Moreover, the smoothing step may be performed with a smoothing device, such as a smoothing device supplied by Ytron, at a rotation speed of from 20 Hz to 60 Hz, preferably from 20 Hz to 40 Hz, most preferably from 25 Hz to 35 Hz. The smoothing step enables to smooth and homogenize the gel obtained after fermentation into a homogenous fermented dairy product analogue having no or limited grainy texture. Especially, the smoothing device shall minimize the loss of viscosity that may occur after the smoothing step.

The fermented dairy product analogue may be cooled after fermentation until reaching chilled conditions if it is chilled or until reaching chilled or ambient conditions if it is shelf-stable. This cooling step may occur after smoothing step or after the heat-treatment after fermentation, if any.

In a second aspect, the invention also relates to a fermented dairy product analogue.

The composition of the fermented dairy product analogue is described in the embodiments of the first aspect of the invention.

In an embodiment, the fermented dairy product analogue comprises a hydrophilic liquid. Details and advantages related to the hydrophilic liquid are provided in the first aspect of the invention. The fermented dairy product analogue may comprise from 60 wt. % to 97 wt. %, preferably from 70 wt. % to 95 wt. %, more preferably from 80 wt. % to 95 wt. % of hydrophilic liquid with respect to the total weight of the fermented dairy product analogue.

In an embodiment, the fermented dairy product analogue comprises at least one non-dairy ingredient. The non-dairy ingredient comprises beta-glucans. The non-dairy ingredient is selected from the group consisting of plant ingredient, fungal ingredient or a combination thereof. Preferably, the non-dairy ingredient is a cereal ingredient. Details and advantages related to the non-dairy ingredient, the fungal ingredient, the plant ingredient and the cereal ingredient are provided in the embodiments of the first aspect of the invention. In an embodiment, the fermented dairy product analogue may comprise at least 0.5 wt. %, preferably from 0.5 to 35.0 wt. %, more preferably from 1.0 to 10.0 wt. %, even more preferably from 1.0 to 5.0 wt. % of non-dairy ingredient with respect to the total weight of the fermented dairy product analogue. Advantages of such content ranges are provided in the embodiments of the first aspect of the invention.

In an embodiment, the fermented dairy product analogue comprises ascorbic acid. Details and advantages related to the ascorbic acid are provided in the embodiments of the first aspect of the invention. In an embodiment, the fermented dairy product analogue may comprise preferably from 0.05 wt. % to 0.60 wt %, more preferably from 0.05 wt. % to 0.50 wt. %, of ascorbic acid with respect to the total weight of the fermented dairy product analogue. Advantages of such content ranges are provided in the embodiments of the first aspect of the invention. The ascorbic acid is exogenous. By “exogenous”, it is understood that the ascorbic acid is externally added during the preparation of the fermented dairy product analogue and is not provided endogenously by the other ingredients of the fermented dairy product analogue. In particular, it refers to ascorbic acid, which is not inherently present in the non-dairy ingredient, the hydrophilic liquid, the vegetable fat component, the fermentable sugar component, the plant protein ingredient and the starter culture.

In an embodiment, the fermented dairy product analogue may further comprise at least one ingredient from the group consisting of a plant protein ingredient which is different from the non-dairy ingredient, a vegetable fat component, a fermentable sugar component or combination thereof as described in the embodiments of the first aspect of the invention.

In a particular embodiment, the fermented dairy product analogue may have a total protein content of at least 0.5 wt. %, preferably of 0.5 wt. % to 8 wt. %, more preferably of 1.5 wt. % to 6.0 wt. %, most preferably of 2.5 wt. % to 5.5 wt. % with respect to the total weight of the fermented dairy product analogue. In another particular embodiment, the fermented dairy product analogue may have a total fat content of at least 0.1 wt. %, preferably of 0.1 wt. % to 10 wt. %, more preferably of 1 wt. % to 10 wt. %, most preferably of 1.5 wt. % to 8 wt. % with respect to the total weight of the fermented dairy product analogue. In another particular embodiment, the fermented dairy product analogue may have a total sugar content of at least 0.1 wt. %, preferably of 0.1 wt. % to 15 wt. %, more preferably of 1.0 wt. % to 12 wt. %, most preferably of 1.5 wt. % to 8 wt. % with respect to the total weight of the fermented dairy product analogue.

In an embodiment, the fermented dairy product analogue may comprise a starter culture as provided in the embodiments of the first aspect of the invention. Preferably, the starter culture is in a living state.

In an embodiment, the fermented dairy product analogue may have a protein digestibility-corrected amino acid score (PDCAAS) of at least 0.6, preferably of 0.6 to 1.0, more preferably of 0.8 to 1.0. For example, high PDCAAS may be achieved by combining the non-dairy ingredient, in particular cereal ingredient, with a plant protein ingredient comprising pulse proteins.

The protein digestibility-corrected amino acid score (PDCAAS) is a method of evaluating the quality of a protein based on both the amino acid requirements of humans and their ability to digest it. PDCAAS compares the amount of the essential amino acids in a food to a reference (scoring) pattern based on the essential amino acid requirements of a preschool-age child to determine its most limiting amino acid (amino acid score). This approach is recommended by the Food and Drug Administration (FDA) and is described in the 1991 FAO/WHO Protein Quality Report.

In a preferred embodiment, the fermented dairy product analogue may be free from dairy ingredients and/or from soy. Advantageously, it may also be free from beta-glucan-degrading enzymes, in particular enzymes comprising beta-glucanase activity or side activity. More advantageously, the fermented dairy product may be free from any carbohydrate-degrading enzymes. For example, the carbohydrate-degrading enzymes may be selected from the group consisting of enzymes comprising beta-glucanase activity or side-activity, enzymes comprising alpha-amylase activity or side activity, enzymes comprising beta-amylase activity or side activity, enzymes comprising amyloglucosidase activity or side activity, enzymes comprising pullulanase activity or side activity or a combination thereof. Even more advantageously, the fermented dairy product may be free from any added enzymes.

In a more preferred embodiment, the fermented dairy product analogue may be obtainable or obtained by the process according to the embodiments of the first aspect of the invention. In particular, the features of the fermented dairy product analogue described in the embodiments of the first aspect of the invention apply to fermented dairy product analogue according to the second aspect of the invention, and vice versa.

The fermented dairy product analogue according to the second aspect of the invention has a good and pleasant texture. In particular, it has reduced sliminess and/or stickiness despite the use of non-dairy ingredients, in particular fungal ingredients and/or plant ingredients, preferably cereal ingredients, which comprise substantial content of beta-glucans. The use of ascorbic acid significantly contributes to provide a good and pleasant texture.

The sliminess and the stickiness may be assessed by panellists which are trained to assess respectively the sliminess and the stickiness of food products, in particular fermented dairy product analogues. In particular, the panellists assess the sliminess or the stickiness by providing a score from 0 to 10. A score of 0 corresponds to products which are not slimy or sticky while a score of 10 corresponds to products which are extremely slimy or sticky.

The sliminess and the stickiness may also be assessed by measuring the adhesiveness, which is expressed in gram-second (i.e. g.s). The adhesiveness relates to the work necessary to overcome the attractive forces between the surface of the food and the surface of other materials with which the food comes in contact. The lower the adhesiveness is, the lower the sliminess and the stickiness are.

The adhesiveness may be measured by means of a texturometer, in particular TA.TX plus C Texture Analyser (Stable Micro Systems, Surrey, UK), which is equipped with 30 mm diameter cylindrical flat probe penetrating into the samples at a penetration speed of 15.0 mm/s, a maximum penetration depth of 20 mm, and a trigger force of 0.1 N. The adhesiveness may be measured at a temperature of 8° C. In particular, the samples may be stored at a temperature of 8° C. for a minimum of 2 hours prior to measurement. The adhesiveness is represented as the negative area of the force-time curve (g.s) during the ascent of the probe.

In a third aspect of the invention, the invention relates to a method for reducing the adhesiveness of a fermented dairy product analogue. Details on the fermented dairy product are provided in the embodiments of the first and second aspects of the invention. In particular, the fermented dairy product analogue may be fermented dairy product analogue as provided in the embodiments of the second aspect of the invention.

The adhesiveness is correlated with the sliminess and the stickiness of a food product. In particular, a reduction of the sliminess and the stickiness of a food product is translated by a reduction of its adhesiveness. Details on the sliminess and the stickiness are provided in the embodiments of the first and second aspects of the invention. The embodiments of the second aspect of the invention also provide details on the adhesiveness, including a method for measuring it.

In an embodiment, the method comprises the step of adding ascorbic acid to an edible suspension before the fermentation of said edible suspension with a starter culture. In an embodiment, the edible suspension comprises hydrophilic liquid and at least one non-dairy ingredient. Preferably, the non-dairy ingredient comprises beta-glucans.

In an embodiment, the non-dairy ingredient is selected from the group consisting of plant ingredient, fungal ingredient or a combination thereof. In a preferred embodiment, the non-dairy ingredient is a cereal ingredient.

Further details on the ascorbic acid, starter culture, edible suspension, non-dairy ingredient, fungal ingredient, plant ingredient, cereal ingredient and hydrophilic liquid are provided in the embodiments of the first and second aspects of the invention. The fermentation may be performed as provided in the embodiments of the first aspect of the invention.

It has been discovered that the addition of ascorbic acid into a suspension comprising fungal ingredients and/or plant ingredients having a substantial content of beta-glucans, preferably cereal ingredients, enables to significantly improve the texture of the resulting fermented dairy product analogue by reducing its sliminess and/or stickiness. This reduction in sliminess and/or stickiness is translated by a reduction of the adhesiveness.

In an embodiment, the method may comprise a step of heat-treating the edible suspension after the addition of ascorbic acid and before fermentation to prevent any development of unwanted micro-organisms over time. The heat-treatment condition may be as provided for heat-treatment step d) in the first aspect of the invention.

In a preferred embodiment, the ascorbic acid may be added at least 20 minutes, preferably from 20 minutes to 150 minutes, more preferably from 30 minutes to 130 minutes before fermentation or before heat-treatment, if any heat-treatment before fermentation.

Without wishing to be bound by theory, it is believed that this allows to maximize the beneficial effect of the ascorbic acid on the texture, in particular on the adhesiveness and so on the sliminess and/or stickiness of the fermented dairy product analogues. Outside this range, it is believed that the effectiveness of the ascorbic acid is reduced due to insufficient reaction time or due to undesirable side reactions.

In a fourth aspect, the invention relates to the use ascorbic acid for reducing the adhesiveness of a fermented dairy product analogue, wherein the fermented dairy product analogue comprises at least one non-dairy ingredient. In an embodiment, the non-dairy ingredient comprises beta-glucans and is selected from the group consisting of fungal ingredient, plant ingredient and a combination thereof. Preferably, the non-dairy ingredient is a cereal ingredient.

Details on the fermented dairy product analogue, the ascorbic acid, the non-dairy ingredient, the fungal ingredient, the plant ingredient, the cereal ingredient are provided in the embodiments of the first and second aspects of the invention. In particular, the fermented dairy product analogue may be fermented dairy product analogue as provided in the embodiments of the second aspect of the invention.

As mentioned above, it has been observed that the use of ascorbic acid allows to significantly improve the texture of fermented dairy product analogue prepared with fungal ingredients and/or plant ingredients, in particular cereal ingredients, which comprise substantial content of beta-glucans. In particular, it enables to reduce the sliminess and/or stickiness of such fermented dairy product analogues. This is translated by a reduction of the adhesiveness.

In an embodiment, the fermented dairy product analogue is obtained by fermenting an edible suspension with starter culture. In an embodiment, the edible suspension may comprise hydrophilic liquid and at least one non-dairy ingredient. In an embodiment, the non-dairy ingredient may comprise beta-glucans and may be selected from the groups consisting of fungal ingredient, plant ingredient and a combination thereof. Preferably, the non-dairy ingredient is a cereal ingredient. Further details on the edible suspension, the hydrophilic liquid, the non-dairy ingredient, the fungal ingredient, the plant ingredient, the cereal ingredient are provided in the embodiments of the first and second aspects of the invention. The fermentation may be performed as provided in the embodiments of the first aspect of the invention.

In an embodiment, the ascorbic acid may be added before fermentation of the edible suspension.

In a further embodiment, the edible suspension may be heat-treated after the addition ascorbic acid and before fermentation. The heat-treatment condition may be as provided for the first heat-treatment step (cf. step d) in the first aspect of the invention.

In a preferred embodiment, the ascorbic acid may be added at least 20 minutes, preferably from 20 minutes to 150 minutes, more preferably from 30 minutes to 130 minutes before fermentation or before heat-treatment, if any heat-treatment before fermentation. Without wishing to be bound by theory, it is believed that this allows to maximize the beneficial effect of the ascorbic acid on the texture, in particular on the adhesiveness and so on the sliminess and/or stickiness of the fermented dairy product analogues. Outside this range, it is believed that the effectiveness of the ascorbic acid is reduced due to insufficient reaction time or due to undesirable side reactions.

Details on the sliminess and the stickiness are provided in the embodiments of the first and second aspects of the invention. The embodiments of the second aspect of the invention provides details on the adhesiveness, including method for measuring it.

Those skilled in the art will understand that they can freely combine all features of the present invention disclosed herein. In particular, features described for the product of the present invention may be combined with the use and the methods of the present invention and vice versa. Further, features described for different embodiments of the present invention may be combined.

Further advantages and features of the present invention are apparent from the figures and non-limiting examples.

### Examples

### Example 1: Method for measuring the adhesiveness

The samples were stored at a temperature of 8° C. for a minimum of 2 hours prior to measurement. The adhesiveness of different samples was measured at 8° C. using a TA.TX plus C Texture Analyser (Stable Micro Systems, Surrey, UK) equipped with 30 mm diameter cylindrical flat probe. The measuring protocol was set at a penetration speed of 15.0 mm/s, a maximum penetration depth of 20 mm, and a trigger force of 0.1 N.

The results were represented in a force time curve. Adhesiveness is represented as the negative area of the force-time curve (g.s) during the ascent of the probe. In other words, it is the pull on the probe as it lifts off the sample.

### Example 2: Effect of Ascorbic Acid on the Adhesiveness, i.e. Sliminess and Stickiness, of Fermented Dairy Product Analogues Comprising Cereal Flour and Pulse Proteins

4 different plant-based yogurt analogues comprising oat flour and pulse proteins (pea or faba) were prepared with or without ascorbic acid.

In particular, cereal suspensions were prepared in a Thermomix. 3 wt % of sugar was first dissolved in softened water. Then, pulse protein isolate (faba or pea) was added to reach an amount of 2.35 wt % pulse proteins (faba or pea) while mixing until full dispersion at room temperature. Then, 6.7 wt % of the non-hydrolysed oat flour (4 wt % beta glucans) and 3 wt % sunflower oil were added and continued stirring in the Thermomix at speed 3 for 10 min at room temperature to obtain cereal suspensions.

At room temperature, 0.05 wt % ascorbic acid was then added to some cereal suspensions and was stirred for 20 min at 60° C. to allow full hydration of the ingredients. Some cereal suspensions were not added with ascorbic acid. These samples without ascorbic acid were used as control.

The different cereal suspensions were then immediately homogenized at 200 bars in a table-top homogenizer GEA Panda 2000 (GEA Group, Aktiengesellschaft, Switzerland) and pasteurized at 90° C. for 10 minutes. The cereal suspensions were divided in ˜100g samples. Thereafter, the cereal suspension samples were inoculated with a starter culture comprising Bifidobacterium sp., Lactobacillus acidophilus, Lactobacillus delbrueckii sub. bulgaricus, Lactobacillus paracasei, and Streptococcus thermophilus (=starter culture A). Some of the cereal suspensions were further inoculated with Lactobacillus johnsonii Lj1 (Lj1) in addition to the starter culture A. After inoculation, the cereal suspensions were fermented in 125 ml plastic pots at 37° C. until reaching a pH of 4.6+0.02 to obtain plant-based yogurt analogues. The samples were then immediately cooled down to 8° C. and then stored at the same temperature.

The adhesiveness of the different samples was measured in the same pot in which they were fermented according to the method provided in example 1 to assess the stickiness and the sliminess of the different samples. A one-way ANOVA was used to assess differences between the control (i.e. samples without added ascorbic acid) and the samples with added ascorbic acid.

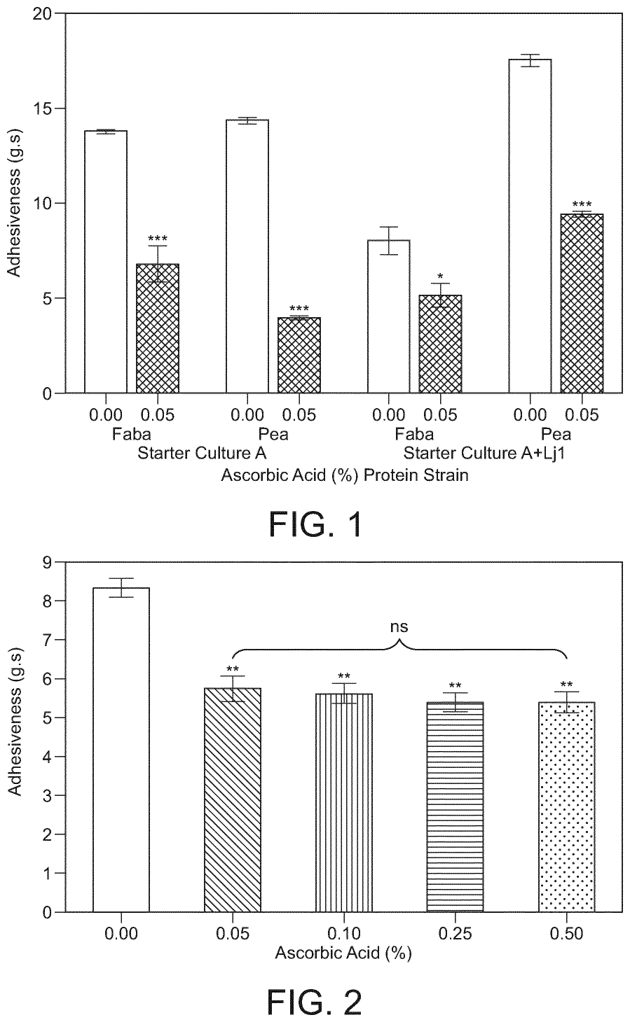

The results are exhibited in FIG. 1. These results show that 0.05 wt % ascorbic acid effectively reduces the adhesiveness of the gels of the plant-based yogurt analogues, regardless the pulse proteins used and the presence or not of Lactobacillus johnsonii Lj1. This is translated by a reduction of the sliminess and stickiness upon visual inspection and tasting.

Therefore, ascorbic acid can be effectively used to reduce the slimy and sticky texture of a plant-based yogurt analogue prepared with a cereal ingredient comprising a substantial content of beta-glucans, in particular non-hydrolysed oat flour. This reduction of sliminess/stickiness is even achieved without using any beta-glucan-degrading enzymes.

### Example 3: Effect of the Ascorbic Acid Concentration on the Adhesiveness, i.e. Sliminess and/or Stickiness, of Fermented Dairy Product Analogues Comprising Cereal Flour and without Pulse Proteins

Different plant-based yogurt analogues comprising oat flour (without pulse proteins) were prepared with different concentration of ascorbic acid.

In particular, cereal suspensions were prepared in a Thermomix. 3 wt % sugar was first dissolved in softened water. Then, 6.7 wt % of the non-hydrolysed oat flour and 3 wt % sunflower oil were added and continued stirring in the Thermomix at speed 3 for 10 min at room temperature to obtain cereal suspensions.

0, 0.05, 0.1, 0.25, or 0.5 wt % ascorbic acid was then added to the cereal suspension and stirred for 20 minutes at 60° C. The cereal suspension without ascorbic acid was used as control.

The different cereal suspensions were then immediately homogenized at 200 bars in a table-top homogenizer GEA Panda 2000 (GEA Group, Aktiengesellschaft, Switzerland) and pasteurized at 90° C. for 10 minutes. The cereal suspensions were divided in ˜100 g samples. Thereafter, the cereal suspension samples were inoculated with the starter culture A of example 2. After inoculation, the cereal suspensions were fermented in 125 mL plastic pots at 37° C. for 4.5 hours to obtain plant-based yogurt analogues. The samples were then immediately cooled down to 8° C. and stored at the same temperature.

The adhesiveness of the different samples was measured in the same pot in which they were fermented according to the method provided in example 1 to assess the stickiness and the sliminess of the different samples. A one-way ANOVA was used to assess differences between the control (i.e. samples without added ascorbic acid) and the samples with added ascorbic acid.

The results are exhibited in FIG. 2. As in example 2, it is observed that ascorbic acid effectively reduces the adhesiveness of the plant-based yogurt analogues based on cereal ingredients high in beta-glucans, i.e., non-hydrolysed oat flour. This is translated by a reduction of the sliminess and the stickiness upon visual inspection and tasting.

FIG. 2 underlines that this reduction is achieved even in the absence of any pulse proteins. This tends to suggest that ascorbic acid acts on the component of the cereal flour to reduce the adhesiveness, and so the sliminess and/or the stickiness of the plant-based yogurt analogues.

In addition, the dose-dependent effect study (FIG. 2) showed that adding ascorbic acid in the range of from 0.05 wt % to 0.50 wt % significantly decreases the adhesiveness of the gel (≥5.74 g.s) of plant-based yogurt analogues compared to the control, i.e. 0% added ascorbic acid (8.34 g.s).

### Example 4: Effect of the Ascorbic Acid Concentration on the Adhesiveness, i.e. Sliminess and/or Stickiness of Fermented Dairy Product Analogues not According to the Invention Prepared with Ingredients with Low or No Beta-Glucans

Different plant-based yogurt analogues were prepared with ingredients with low content of or no beta-glucans. In particular, a first set of samples was prepared with ingredient consisting of starch: corn starch (0 wt % beta-glucans). A second set of samples was prepared with a cereal ingredient with low content of beta-glucans: non-hydrolysed rice flour (below 0.5 wt. % beta glucans).

In particular, suspensions were prepared in a Thermomix. 3 wt % sugar was first dissolved in softened water. Then, 3 wt % sunflower oil and 3 wt % of corn starch or 5 wt % non-hydrolysed rice flour were added and continued stirring in the Thermomix at speed 3 for 10 min at room temperature to obtain cereal suspension.

0 or 0.05 wt % ascorbic acid was then added to the suspension and stirred for 20 minutes at 60° C. The suspension without ascorbic acid was used as control.

The different suspensions were then immediately homogenized at 200 bars in a table-top homogenizer GEA Panda 2000 (GEA Group, Aktiengesellschaft, Switzerland) and pasteurized at 90° C. for 10 minutes. The suspensions were divided in ˜100 g samples. Thereafter, the suspension samples were inoculated with the starter culture A of example 2. After inoculation, the cereal suspensions were fermented in 125 ml plastic pots at 37° C. for 4.5 hours to obtain plant-based yogurt analogues. The samples were then immediately cooled down to 8° C. and stored at the same temperature.

The adhesiveness of the different samples was measured in the same pot in which they were fermented according to the method provided in example 1 to assess the stickiness and the sliminess of the different samples. A one-way ANOVA was used to assess differences between the control (i.e. samples without added ascorbic acid) and the samples with added ascorbic acid.

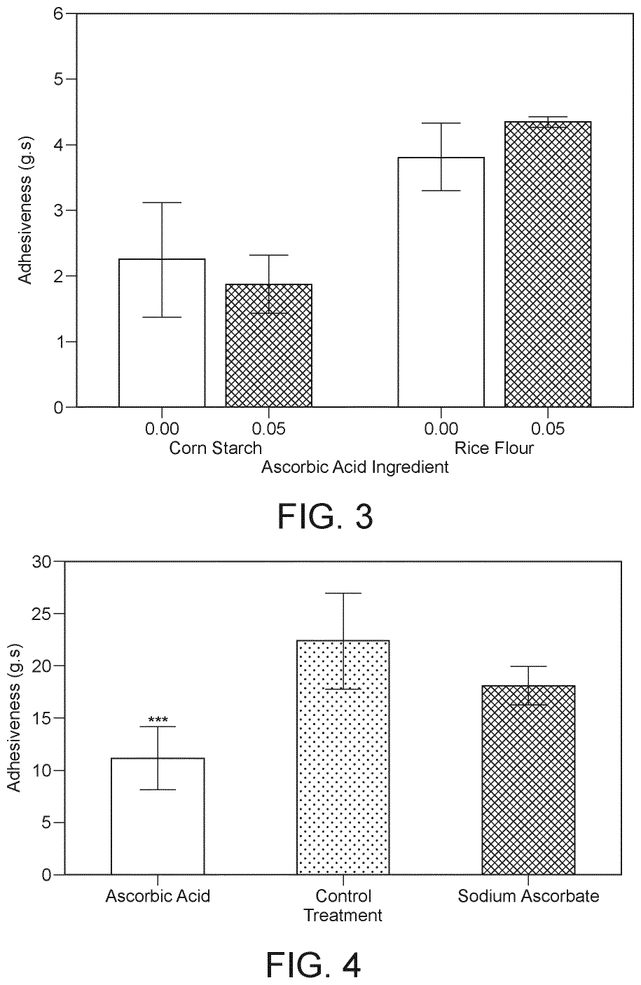

The results are exhibited in FIG. 3. The adhesiveness of each sample containing ascorbic acid was compared to that of its control (i.e. without ascorbic acid). For samples with corn starch and samples with rice flour, no significant differences (at an α=0.05) were found between the adhesiveness of samples with 0.05 wt % ascorbic acid and the adhesiveness of samples without ascorbic.

Corn starch does not comprise beta-glucans and rice flour has poor amount of beta-glucans.

Without wishing to be bound by theory, these results tend to suggest that ascorbic acid acts on the beta-glucans to decrease the adhesiveness of fermented dairy analogues, and therefore to decrease the sliminess and the stickiness of fermented dairy analogues.

### Example 5: Preparation of Plant-Based Yogurt Analogues According to the Invention with an Oat Protein Concentrate

A plant-based yogurt analogue according to the invention was prepared as follows. First, a cereal suspension was prepared by mixing the ingredients of Table 1, except the ascorbic acid and the starter culture.

TABLE 1

| Ingredients | wt % |
|---|---|
| Water | 86.4486 |
| Sucrose | 4.10 |
| Oat protein concentrate (2.2% beta-glucans) | 4.10 |
| Pea protein isolate | 3.00 |
| Ascorbic acid | 0.15 |
| Vegetable oil | 1.75 |
| Starch | 0.40 |
| Inulin | 0.05 |
| Starter culture | 0.0014 |

After the cereal suspension was prepared, 0.15 wt. % ascorbic acid was added to the cereal suspension. 120 minutes after the addition of the ascorbic, the cereal suspension was homogenized at 150/50 bars at a temperature of 60° C. and then pasteurized by applying a heat-treatment at 92° C. for 6 minutes. The obtained cereal suspension was then inoculated with a starter culture, in particular starter culture A of example 2, and is fermented until reaching a pH of 4.6 to obtain a plant-based yogurt analogue. The resulting plant-based yogurt analogue was smoothed, cooled down to 8° C. and stored at the same temperature.

The obtained plant-based yogurt analogue was tasted. It was observed that he had a pleasant texture, in particular a very low slimy and sticky texture.

### Example 6: Preparation of Plant-Based Yogurt Analogues According to the Invention with a Non-Hydrolyzed Oat Flour

A plant-based yogurt analogue according to the invention was prepared as follows.

First, a cereal suspension was prepared by mixing the ingredients of Table 2, except the ascorbic acid and the starter culture.

TABLE 2

| Ingredients | wt % |
|---|---|
| Water | 85.4486 |
| Sucrose | 4.10 |
| Non-hydrolyzed oat flour (4% beta-glucans) | 5.00 |
| Pea protein isolate | 3.00 |
| Ascorbic acid | 0.15 |
| Vegetable oil | 1.75 |
| Starch | 0.40 |
| Inulin | 0.05 |
| Starter culture | 0.0014 |

After the cereal suspension was prepared, 0.15 wt. % ascorbic acid was added to the cereal suspension. 40 minutes after the addition of the ascorbic, the cereal suspensions was homogenized at 150/50 bars at a temperature of 60° C. and then pasteurized by applying a heat-treatment at 92° C. for 6 minutes. The obtained cereal suspension was then inoculated with a starter culture, in particular starter culture A of example 2, and is fermented until reaching a pH of 4.6 to obtain a plant-based yogurt analogue. The resulting plant-based yogurt analogue was smoothed, cooled down to 8° C. and stored at the same temperature.

The obtained plant-based yogurt analogue was tasted. It had very low slimy and sticky texture.

### Example 7: Effect of Ascorbic Acid and Sodium Ascorbate on the Adhesiveness, i.e. Sliminess and/or Stickiness of Shelf-Stable Fermented Dairy Product Analogues Comprising Cereal Flour and Pulse Proteins

A comparison of the effect of ascorbic acid versus sodium ascorbate was carried out in order to assess if the reduction of the adhesiveness, i.e. sliminess and/or stickiness, of plant-based fermented dairy analogues could also be observed when using a salt form of ascorbic acid, in particular a salt including ascorbate.

In addition, shelf-stable fermented dairy product analogues were prepared to assess if the reduction of the sliminess and/or stickiness can be observed in shelf-stable fermented dairy product analogues.

Different plant-based yogurt analogues comprising oat flour and pulse proteins, in particular faba bean proteins, were prepared with or without ascorbic acid or sodium ascorbate.

In particular, cereal suspensions were prepared in a Thermomix. 3 wt % sugar was first dissolved in softened water. Then, faba bean protein isolate was added to reach an amount of 2.5 wt % faba bean proteins while mixing until full dispersion. Then, 6.4 wt % of the non-hydrolysed oat flour (4 wt % beta glucans) and 3 wt % sunflower oil were added and continued stirring in the Thermomix at speed 3 for 10 min at room temperature to obtain cereal suspensions.

0.05 wt % of ascorbic acid or sodium ascorbate was then added to some cereal suspensions and was stirred for 20 min at 60° C. to allow full hydration of the ingredients. Some cereal suspensions were not added with ascorbic acid nor sodium ascorbate. These samples without ascorbic acid and sodium ascorbate were used as controls.

The different cereal suspensions were then pasteurized at 90° C. for 10 minutes then homogenized (downstream) at 200 bars in a table-top homogenizer HP202 Twin Panda 600 (GEA Group, Aktiengesellschaft, Switzerland). Thereafter, the cereal suspension samples were inoculated with starter culture A of example 2. After inoculation, half batch of the cereal suspensions were fermented in 125 mL plastic pots at 43° C. until reaching a pH of 4.6±0.02 to obtain a “chilled” plant-based yogurt analogues; the other half was fermented under the same conditions in glass jar for further processing to produce “shelf-stable” plant-based yogurt analogues.

Once the pH was reached, the “chilled” samples which were fermented in plastic pots were immediately cooled down to 8° C. and then stored at the same temperature.

The “shelf-stable” samples which were fermented in a glass jar were stirred manually then submitted to a second heat treatment at 109° C. for 30 s; conditions that are enough to ensure a shelf-life of 6 to 9 months at room temperature when packed aseptically.

The adhesiveness of the different “chilled” samples was measured according to the method provided in example 1 to assess the stickiness and the sliminess of the different samples. A one-way ANOVA was used to assess differences between the control (i.e. samples without added ascorbic acid) and the samples with added ascorbic acid.

The results for the “chilled” samples are exhibited in FIG. 4. These results show that 0.05 wt % ascorbic acid effectively reduces the adhesiveness (α=0.05) of the gels of the plant-based yogurt analogues, whereas the effect of its sodium ascorbate salt was not significant (statistical tests run at an α=0.05 and 0.1). In particular, no significant decrease in adhesiveness can be observed when sodium ascorbate is used.

For the “shelf-stable” samples, upon visual inspection and tasting, it has been noticed that the sliminess and stickiness was decreased in yogurt analogues with ascorbic acid versus control without ascorbic acid/sodium ascorbate. In opposition, upon visual inspection and tasting, no differences in the sliminess and stickiness were found between yogurt analogues with sodium ascorbate and control without ascorbic acid/sodium ascorbate.

Therefore, it can be concluded that ascorbic acid can be effectively used to reduce the adhesiveness, and therefore to reduce the slimy and sticky texture of chilled and shelf-stable fermented dairy product analogues prepared with a cereal ingredient comprising a substantial content of beta-glucans. This decrease in adhesiveness and so in sliminess/stickiness cannot be achieved, for either chilled or shelf-stable format, when sodium ascorbate is used instead. Although the invention has been described by way of example, it should be appreciated that variations and modifications may be made without departing from the scope of the invention as defined in the claims.

### Example 8: Effect of the Reaction Time Between Ascorbic Acid and the Non-Dairy Ingredient and Effect of the Timing in the Addition Step of Acid Ascorbic in the Process on the Adhesiveness, i.e. Sliminess and/or Stickiness, of the Fermented Dairy Product Analogues Comprising Cereal Flour and Pulse Proteins

2 different plant-based yogurt analogues comprising 6.7 wt % of the non-hydrolysed oat flour (4 wt % beta glucans) and 0.05 wt % of ascorbic acid were prepared at room temperature in the Thermomix and left reacted respectively for 2 minutes and for 20 minutes under continued stirring. After 2 minutes and after 20 minutes, the reactions were respectively neutralized by adding a NaOH (30% w/w) solution until reaching a pH of 6.5-6.6.

After the neutralization step, pea protein isolate in order to reach an amount of 2.35 wt % pea proteins, 3 wt % of sugar and 3 wt % sunflower oil were added and continued stirring in the Thermomix at speed 3 for 10 min at room temperature to obtain cereal suspensions.

The different suspensions were then immediately homogenized at 200 bars in a table-top homogenizer GEA Panda 2000 (GEA Group, Aktiengesellschaft, Switzerland) and pasteurized at 90° C. for 10 minutes. The suspensions were divided in ˜100 g samples. Thereafter, the suspension samples were inoculated with the starter culture A of example 2. After inoculation, the cereal suspensions were fermented in 125 ml plastic pots at 37° C. for 4.5 hours to obtain plant-based yogurt analogues. The samples were then immediately cooled down to 8° C. and stored at the same temperature.

Another plant-based yogurt analogue BF was prepared in a Thermomix. 3 wt % sugar was first dissolved in softened water. Then, pea protein isolate was added to reach an amount of 2.5 wt % pea proteins while mixing until full dispersion. Then, 6.4 wt % of the non-hydrolysed oat flour (4 wt % beta glucans) and 3 wt % sunflower oil were added and continued stirring in the Thermomix at speed 3 for 10 min at room temperature to obtain cereal suspensions.

The suspension was then immediately homogenized at 200 bars in a table-top homogenizer GEA Panda 2000 (GEA Group, Aktiengesellschaft, Switzerland) and pasteurized at 90° C. for 10 minutes.

Then, the pasteurized suspension was cooled down to 60° C. and 0.05 wt % of ascorbic acid was added to the suspension and stirred for 20 minutes at 60° C. The suspensions were divided in ˜100 g samples. Thereafter, the suspension samples were inoculated with the starter culture A of example 2. After inoculation, the cereal suspensions were fermented in 125 mL plastic pots at 37° C. for 4.5 hours to obtain plant-based yogurt analogues. The samples were then immediately cooled down to 8° C. and stored at the same temperature.

The adhesiveness of the 3 above-detailed samples was measured in the same pot in which they were fermented according to the method provided in example 1 to assess the stickiness and the sliminess of the different samples. A one-way ANOVA was used to assess differences between the control (i.e. samples without added ascorbic acid) and the samples with added ascorbic acid.

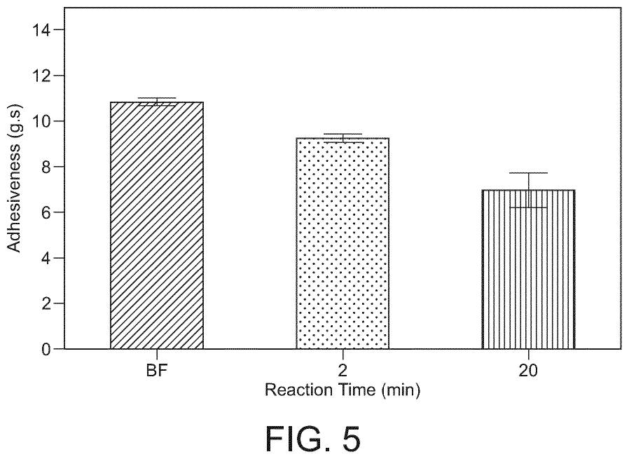

The results are exhibited in FIG. 5. These results show that the reaction time between the non-dairy ingredient and ascorbic acid should be at least of 20 minutes in order to reduce effectively the adhesiveness of the gels of the plant-based yogurt analogues. This is translated by a reduction of the sliminess and stickiness upon visual inspection and tasting. These results also show that the timing of introduction of ascorbic acid is also important in order to reduce effectively the adhesiveness of the gels of the plant-based yogurt analogues. In fact, ascorbic acid should be added before the pasteurization of the plant-based yogurt analogues in order to see a reduction of the adhesiveness and therefore a reduction the sliminess and stickiness of said analogues.

1. Process for preparing a fermented dairy product analogue comprising the steps of:
a) providing an edible suspension comprising hydrophilic liquid and at least one non-dairy ingredient, wherein the non-dairy ingredient comprises beta-glucans and wherein the non-dairy ingredient is selected from the group consisting of plant ingredient, fungal ingredient and a combination thereof,
b) adding ascorbic acid into the edible suspension to obtain an edible suspension comprising ascorbic acid,
c) homogenizing the edible suspension comprising ascorbic acid,
d) heat-treating the edible suspension comprising ascorbic acid,
e) inoculating the homogenised and heat-treated edible suspension comprising ascorbic acid with a starter culture to obtain an inoculated edible suspension comprising ascorbic acid, and
f) fermenting the inoculated edible suspension comprising ascorbic acid until reaching a pH of less than 5.0 to obtain a fermented dairy product analogue.

2. Process according to claim 1, wherein the non-dairy ingredient comprises at least 0.5 wt. % beta-glucans, with respect to the total weight of the non-dairy ingredient.

3. Process according to claim 1, wherein the non-dairy ingredient is a cereal ingredient.

4. Process according to claim 3, wherein the cereal ingredient is originated from the group consisting of oat, barley, rye, wheat and a combination thereof.

5. Process according to claim 3, wherein the cereal ingredient is cereal flour.

6. Process according to claim 1, wherein the edible suspension comprises 1.0 to 15 wt % non-dairy ingredient with respect to the total weight of the edible suspension.

7. Process according to claim 1, wherein the edible suspension comprises at least 0.01 wt. % ascorbic acid with respect to the total weight of the edible suspension.

8. Process according to claim 1, wherein the edible suspension comprising ascorbic acid further comprises at least one plant protein ingredient which is different from the non-dairy ingredient, and which is selected from the group consisting of plant protein concentrate, plant protein isolate, plant protein flour and a mixture thereof.

9. Process according to claim 8, wherein the plant protein ingredient comprises pulse proteins.

10. Process according to claim 9, wherein the pulse proteins are selected from the group consisting of pea proteins, faba bean proteins and a mixture thereof.

11. Process according to claim 1, wherein the ascorbic acid is added at least 20 minutes minutes before the heat-treatment step d).

12. A fermented dairy product analogue which comprises:
hydrophilic liquid,
at least one non-dairy ingredient, wherein the non-dairy ingredient comprises beta-glucans and wherein the non-dairy ingredient is selected from the group consisting of plant ingredient, fungal ingredient and a combination thereof, and
ascorbic acid.

13. (canceled)

14. A method for reducing the adhesiveness of a fermented dairy product analogue which comprises the step of adding ascorbic acid to an edible suspension before fermentation of said edible suspension with a starter culture, wherein said edible suspension comprises hydrophilic liquid and at least one non-dairy ingredient, wherein the non-dairy ingredient comprises beta-glucans and wherein the non-dairy ingredient is selected from the group consisting of plant ingredient, fungal ingredient and a combination thereof.

15. (canceled)

16. A method according to claim 14, wherein the adhesiveness is measured by means of a texturometer which is equipped with 30 mm diameter cylindrical flat probe, at a penetration speed of 15.0 mm/s, at a maximum penetration depth of 20 mm, at a trigger force of 0.1 N and at a temperature of 8° C.
